(19) United States
(12) Patent Application Publication
(10) Pub. No.: US 2025/0229290 A1
(43) Pub. Date: Jul. 17, 2025

(54) Systems and Methods for Space Based Biosensors

(71) Applicant: Ecoatoms, Inc., Reno, NV (US)

(72) Inventors: Solange Massa, Atherton, CA (US); Pablo Echavarria, Reno, NV (US)

(73) Assignee: Ecoatoms, Inc., Reno, NV (US)

(21) Appl. No.: 18/854,934

(22) PCT Filed: Apr. 7, 2023
(86) PCT No.: PCT/US23/65532

§ 371 Date: Oct. 7, 2024

Related U.S. Application Data
(60) Provisional application No. 63/362,643, filed on Apr. 7, 2022.

(51) Int. Cl. B05C 5/02; B64G 4/00

(52) U.S. Cl. CPC B05C 5/027; B64G 4/00

(57) ABSTRACT

In some embodiments A space-based sensor fabrication system contains a fluid containment system connected to a fluid deposition system. The fluid deposition system is set up to manufacture a SAM onto an electrode blank in a microgravity environment. A fabrication chamber that is set up to house and control a number of different fabrication systems in a microgravity, low gravity, and/or no gravity environment. A space-based sensor fabrication system can use surface tension to hold a fluid in place during sensor fabrication.

### CROSS-REFERENCE TO RELATED APPLICATIONS

The current application claims priority to U.S. Provisional Patent Application No. 63/362,643 filed Apr. 7, 2022, the disclosure of which is incorporated herein by reference in its entirety for all purposes.

### FIELD OF THE INVENTION

The present invention generally relates to sensor manufacturing. More specifically the systems and methods for manufacturing sensors in a microgravity environment.

### BACKGROUND

Electrochemical sensors are simple and affordable analytical diagnostic tools that can be used to detect a broad range of molecular analytes. Accordingly, sensors can have a wide range of applications and uses. The size and simplicity of electrochemical sensors can make them cost-effective for a number of different applications and in a number of different fields. However, the effectiveness or sensitivity of the sensor can be greatly determined by the manufacturing process. For example, most sensors are produced by placing a or chemical sensitive material on the surface of an electrode. This process begins with the placement of a Self-Assembled Monolayer (SAM). The SAM is a one molecule thick layer of material that bonds to a surface by way of deposition. This can be done chemically or mechanically. The SAM provides a base layer for which the sensor can be built. The SAM allows for additional coatings with antibodies that will detect the analyte of interest to be applied. The respective sensitivity of the sensor can ultimately be affected by the precision and smoothness of the SAM. Current coating techniques create rough and uneven sensor surfaces that equate to low sensitivity and specificity of the upper layers.

### SUMMARY OF THE DISCLOSURE

Many embodiments are directed to a sensor manufacturing device and a method for manufacturing sensors in a low to no gravity environment. Some embodiments are directed to a payload structure for housing a number of different sensor manufacturing devices. The payload structure can take on any suitable form, and in some embodiments may be a CubeSat or similar. The sensor manufacturing device can contain at least one liquid reservoir and a pump in fluid communication with the liquid reservoir. The pump has at least one inlet and at least one outlet where the inlet is configured to receive fluid from the liquid reservoir and be pumped out through the outlet. The device further has a system of tubing dispersed over a platform, where the platform has a number of different bland and/or bare electrode, where each of the bland and/or bare electrode are positioned directly beneath at least one fluid dispensing elements. Each of the fluid dispensing elements are in fluid communication with the system of tubing and is configured to dispense a predetermined amount of fluid onto the blank and/or bare electrode. Many embodiments are optimized in terms of placement of elements such that the flow of fluid out of the fluid dispensing element occurs at an optimum level in a microgravity, low gravity or no gravity environment.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

In some aspects, the techniques described herein relate to a space-based sensor fabrication module including: a fluid dispensing system, the fluid dispensing system including at least one reservoir, and at least one nozzle, wherein each nozzle corresponds to a reservoir; at least one electrode; and a press mechanism, the press mechanism capable of applying an external force on at least one of the at least one reservoir; wherein the at least one reservoir dispenses a fluid onto the at least one electrode in response to the external force applied.

In some aspects, the techniques described herein relate to a space-based sensor fabrication module, wherein the at least one reservoir is deformed in response to the external force applied, and the deformation causes the fluid to be dispensed.

In some aspects, the techniques described herein relate to a space-based sensor fabrication module, wherein the press mechanism includes a control system, a motor, and a movable component.

In some aspects, the techniques described herein relate to a space-based sensor fabrication module, wherein the press mechanism includes a first plate and a second plate.

In some aspects, the techniques described herein relate to a space-based sensor fabrication module, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a space-based sensor fabrication module, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a space-based sensor fabrication module, wherein the sensor fabrication system is capable of manufacturing a self-assembled monolayer.

In some aspects, the techniques described herein relate to a space-based sensor fabrication module, wherein the at least one reservoir includes a first reservoir and a second reservoir, the at least one nozzle includes a first nozzle and a second nozzle, and the at least one electrode includes a first electrode and a second electrode.

In some aspects, the techniques described herein relate to a space-based sensor fabrication module, wherein the reservoir has a flexible top.

In some aspects, the techniques described herein relate to a space-based sensor fabrication module, wherein a distance between a reservoir tip and the at least one electrode is adjustable.

In some aspects, the techniques described herein relate to a space-based sensor fabrication module, wherein a nozzle positioning relative to the electrode is configured such that a fluid dispensed by the fluid dispensing system is subjected to sufficient surface tension forces to hold the dispensed fluid in place and in contact with the electrode.

In some aspects, the techniques described herein relate to a space-based sensor fabrication module, wherein the fluid dispensing system uses surface tension to apply a layer of material to an electrode.

In some aspects, the techniques described herein relate to a space-based sensor fabrication module, wherein a distance between the nozzle and the electrode is selected such that surface tension of the fluid is sufficient to hold the fluid on the at least one electrode.

In some aspects, the techniques described herein relate to a space-based sensor fabrication chamber including: an outer wall; a press mechanism; at least one fabrication tray; at least one fabrication module coupled to the at least one fabrication tray; and at least one electrode; wherein the fabrication module dispenses a fluid onto the at least one electrode in response to a force applied by the press mechanism.

In some aspects, the techniques described herein relate to a space-based sensor fabrication chamber, wherein the outer wall conforms to a CubeSat form factor.

In some aspects, the techniques described herein relate to a space-based sensor fabrication chamber, wherein the at least one fabrication module includes: a fluid dispensing system, the fluid dispensing system including at least one reservoir, and at least one nozzle, wherein each nozzle corresponds to a reservoir; at least one electrode; and a press mechanism, the press mechanism capable of applying an external force on at least one of the at least one reservoir; wherein the at least one reservoir dispenses a fluid onto the at least one electrode in response to the external force applied.

In some aspects, the techniques described herein relate to a space-based sensor fabrication chamber, wherein the at least one fabrication tray is two or more fabrication trays.

In some aspects, the techniques described herein relate to a space-based sensor fabrication chamber, wherein the at least one fabrication tray is five fabrication trays.

In some aspects, the techniques described herein relate to a space-based sensor fabrication chamber, wherein the at least one fabrication module is two or more fabrication modules per fabrication tray.

In some aspects, the techniques described herein relate to a space-based sensor fabrication chamber, wherein the at least one fabrication tray is six fabrication modules per fabrication tray.

In some aspects, the techniques described herein relate to a space-based sensor fabrication chamber, wherein the press mechanism can apply a force to all reservoirs in a sensor fabrication chamber simultaneously.

In some aspects, the techniques described herein relate to a space-based sensor fabrication chamber, wherein the at least one reservoir is deformed in response to the external force applied, and the deformation causes the fluid to be dispensed.

In some aspects, the techniques described herein relate to a space-based sensor fabrication chamber, wherein the press mechanism includes a control system, a motor, and a movable component.

In some aspects, the techniques described herein relate to a space-based sensor fabrication chamber, wherein the press mechanism includes a first plate and a second plate.

In some aspects, the techniques described herein relate to a space-based sensor fabrication chamber, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a space-based sensor fabrication chamber, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a space-based sensor fabrication chamber, wherein the sensor fabrication system is capable of manufacturing a self-assembled monolayer.

In some aspects, the techniques described herein relate to a space-based sensor fabrication chamber, wherein the at least one reservoir includes a first reservoir and a second reservoir, the at least one nozzle includes a first nozzle and a second nozzle, and the at least one electrode includes a first electrode and a second electrode.

In some aspects, the techniques described herein relate to a space-based sensor fabrication chamber, wherein the reservoir has a flexible top.

In some aspects, the techniques described herein relate to a space-based sensor fabrication chamber, wherein a distance between a reservoir tip and the at least one electrode is adjustable.

In some aspects, the techniques described herein relate to a space-based sensor fabrication system including: a baseplate; a fluid reservoir disposed on a top surface of the baseplate; a pump in fluid communication with the fluid reservoir wherein the pump has at least one inlet and one outlet, where the inlet is configured to receive fluid from the fluid reservoir; and a network of tubing connected to the at least one outlet and in fluid communication with the pump, wherein the network of tubing is disposed above the top surface of the baseplate and configured to dispense fluid through a plurality of fluid dispensing elements by surface tension application; wherein each of the plurality of fluid dispensing elements corresponds to at least one blank and/or bare electrode, wherein each of the at least one blank and/or bare electrode is disposed on the top surface of the baseplate.

In some aspects, the techniques described herein relate to a fabrication chamber including: A plurality of sensor fabrication systems, wherein each of the plurality of sensor fabrication systems includes: a baseplate; a fluid reservoir disposed on a top surface of the baseplate; a pump in fluid communication with the fluid reservoir wherein the pump has at least one inlet and one outlet, where the inlet is configured to receive fluid from the fluid reservoir; and a network of tubing connected to the at least one outlet and in fluid communication with the pump, wherein the network of tubing is disposed above the top surface of the baseplate and configured to dispense fluid through a plurality of fluid dispensing elements by surface tension application; wherein each of the plurality of fluid dispensing elements corresponds to at least one blank and/or bare electrode, wherein each of the at least one blank and/or bare electrode is disposed on the top surface of the baseplate; and at least one control module, wherein the at least one control module is configured to control a functioning of each of the plurality of sensor fabrication systems.

In some aspects, the techniques described herein relate to a chemical deposition process to create a self-assembled monolayer in microgravity that includes: obtaining a bare surface for an application of a chemical substance; applying a head group chemical to the bare surface; applying a functional tail group to a head group, wherein a functional group is configured to operate or interact with an external element thereby causing a reaction.

In some aspects, the techniques described herein relate to a chemical deposition process, further including applying a spacer group between the head group and the functional tail group.

In some aspects, the techniques described herein relate to a chemical deposition process, wherein the functional tail group further serves as a functionalized surface for an immobilization of a group consisting of polymers, chemicals, logical components, (oligo-) nucleotides, proteins, antibodies, and receptors.

In some aspects, the techniques described herein relate to a space-based sensor fabrication system including: a baseplate; and a fluid dispensing structure disposed on a top surface of the baseplate that has a flexible portion that serves as a fluid reservoir and dispensing nozzle. The structure has at least one inlet to load the fluid and one outlet to dispense; wherein each of a plurality of fluid dispensing elements corresponds to at least one blank and/or bare electrode, wherein each of the at least one blank and/or bare electrode is disposed on the top surface of the baseplate.

In some aspects, the techniques described herein relate to a fabrication chamber including: A plurality of sensor fabrication systems, wherein each of the plurality of sensor fabrication systems includes: a baseplate; a fluid dispensing structure disposed on a top surface of the baseplate that has a flexible some that serves as a fluid reservoir and dispensing nozzle. The structure has at least one inlet to load the fluid and one outlet to dispense; wherein each of a plurality of fluid dispensing elements corresponds to at least one blank and/or bare electrode, wherein each of the at least one blank and/or bare electrode is disposed on the top surface of the baseplate; and at least one control module, wherein the at least one control module is configured to control a functioning of each of the plurality of sensor fabrication systems.

In some aspects, the techniques described herein relate to a method for space-based sensor fabrication, the method including: providing a satellite in orbit; activating a press mechanism to apply an external force on at least one reservoir; wherein the at least one reservoir dispenses a fluid through at least one nozzle onto an at least one electrode in response to the external force applied.

In some aspects, the techniques described herein relate to a method for space-based sensor fabrication, wherein the at least one reservoir is deformed in response to the external force applied, and the deformation causes the fluid to be dispensed.

In some aspects, the techniques described herein relate to a method for space-based sensor fabrication, wherein the press mechanism includes a control system, a motor, and a movable component.

In some aspects, the techniques described herein relate to a method for space-based sensor fabrication, wherein the press mechanism includes a first plate and a second plate.

In some aspects, the techniques described herein relate to a method for space-based sensor fabrication, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a method for space-based sensor fabrication, wherein the press mechanism includes a first plate, a second plate, and a second fluid dispensing, and wherein the first fluid dispensing system and the second fluid dispensing system are arranged in series between the first plate and the second plate.

In some aspects, the techniques described herein relate to a method for space-based sensor fabrication, wherein the method for space-based sensor fabrication is capable of manufacturing a self-assembled monolayer.

In some aspects, the techniques described herein relate to a method for space-based sensor fabrication, wherein the at least one reservoir includes a first reservoir and a second reservoir, the at least one nozzle includes a first nozzle and a second nozzle, and the at least one electrode includes a first electrode and a second electrode.

In some aspects, the techniques described herein relate to a method for space-based sensor fabrication, wherein the reservoir has a flexible top.

In some aspects, the techniques described herein relate to a method for space-based sensor fabrication, wherein a distance between a reservoir tip and the at least one electrode is adjustable.

In some aspects, the techniques described herein relate to a method for space-based sensor fabrication, wherein a positioning of the at least one nozzle relative to the at least one electrode is configured such that a fluid dispensed by a fluid dispensing system is subjected to sufficient surface tension forces to hold the dispensed fluid in place and in contact with the electrode.

In some aspects, the techniques described herein relate to a method for space-based sensor fabrication, wherein a fluid dispensing system uses surface tension to apply a layer of material to an electrode.

In some aspects, the techniques described herein relate to a method for space-based sensor fabrication, wherein a distance between the nozzle and the electrode is selected such that surface tension of the fluid is sufficient to hold the fluid on the electrode.

### BRIEF DESCRIPTION OF THE DRAWINGS

The description will be more fully understood with reference to the following figures, which are presented as exemplary embodiments of the invention and should not be construed as a complete recitation of the scope of the invention.

FIG. 1 conceptually illustrates a sensor fabrication device for use in a space-based structure in accordance with embodiments.

FIGS. 2A and 2B conceptually illustrate space-based structures for housing a sensor fabrication device in accordance with embodiments.

FIGS. 3A and 3B conceptually illustrate a space-based structure for housing sensor fabrication devices in accordance with embodiments.

FIGS. 4A and 4B conceptually illustrate a sensor fabrication device and a space-based structure in accordance with embodiments.

FIG. 5 conceptually illustrates a space-based system for housing sensor fabrication devices in accordance with embodiments.

FIG. 6 conceptually illustrates another space-based system for housing sensor fabrication devices in accordance with embodiments.

FIGS. 7A and 7B conceptually illustrate space-based structures and systems in accordance with embodiments.

FIGS. 8A and 8B conceptually illustrate a sensor fabrication device in accordance with embodiments.

FIGS. 9A and 9B conceptually illustrate a sensor fabrication device in accordance with embodiments.

FIG. 10 conceptually illustrates components of a sensor fabrication device in accordance with embodiments.

FIGS. 11A and 11B illustrate various chemical deposition processes for creating a SAM in a micro-gravity, low gravity, or no gravity environment.

FIGS. 12A through 12D conceptually illustrate an example of a sensor fabrication element.

FIGS. 13A through 13D conceptually illustrate an example of a fluid dispensing system.

FIGS. 14A through 14B conceptually illustrate an example of a fabrication chamber with a number of sensor fabrication devices.

FIGS. 15A through 15C conceptually illustrate a cross-section view of an example fluid dispensing system.

FIGS. 16A through 16B conceptually illustrate an example of a fabrication chamber with press mechanism.

FIGS. 17A through 17C conceptually illustrate an example of a manufacturing process being performed by a fabrication chamber.

FIG. 18 conceptually illustrates an example of a camera mounted to observe a deposition site.

FIG. 19 conceptually illustrates an example process for space-based sensor fabrication.

### DETAILED DESCRIPTION

The manufacture of sensors can be a delicate process that requires precision and care in order to produce a highly sensitive and thus highly effective sensor for use. Accordingly, many embodiments are directed to a sensor fabrication device that contains a reservoir for holding a fluid used in depositing a SAM onto an electrode. The reservoir can be in fluid communication with a pump that has an inlet and an outlet where the inlet supplies the fluid from the reservoir to the pump. The outlet can be connected to a series of fluid channels that are interspersed with fluid dispersion elements. Each of the fluid dispersion element can correspond to a respective electrode. The sensor fabrication device can further contain a number of sensors and/or switches. At least one sensor is configured to measure and detect the intensity of gravity with respect to the fabrication device such that it can activate and/or deactivate a pump switch.

Various embodiments can be directed to a method by which the fluid in the reservoir is directed to each of the respective electrodes and a SAM is produced on each of the electrodes.

In accordance with many embodiments of the invention, a fabrication system can have many reservoirs. Each reservoir can be an individual container (e.g., individual polymer container) that can house isolated liquid samples. In several embodiments, the fluid housed inside the reservoirs can be dispensed without the use of a pump. In several embodiments the fluid housed inside the reservoirs can be dispensed using a press mechanism as described in additional detail elsewhere herein.

The current techniques for creating sensors can involve the application of a self-assembled monolayer (SAM) onto an electrode or a functional surface. This can include the initial chemical layer that is applied to a bare and/or blank electrode and/or surface the application of additional chemical layers on top of one or more base layers. This can be mechanical deposition of a chemical layer. The current techniques typically produce rough and uneven surfaces. There are a number of reasons as to why such surfaces may be produced; one being the effects of gravity on the fluid as it is applied. The roughness or unevenness of the SAM can result in sensors that are less sensitive to the desired analyte. The roughness can also affect surface topography and morphology of the sensors surface. This can result in more sensors to be used and thus make it costlier overall, less efficient and accurate.

While various descriptions and embodiments described above correspond to space-based fabrication methods and systems, these descriptions and embodiments can also be applied to terrestrial manufacturing applications.

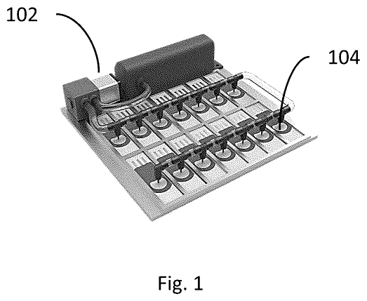

In contrast, many embodiments are directed to a sensor fabrication system that utilizes the dominant force of surface tension to apply a layer of material to an electrode, thus creating a more uniform SAM for improved sensing, performance and/or surface topology. Many embodiments are configured to fit within a small form factor such as a specialized payload or CubeSat forming a fabrication chamber. FIG. 1 for example, illustrates an embodiment of a sensor fabrication element 102 that can be housed within a CubeSat form factor or any other suitable payload transportation element. The sensor fabrication device 102 can have a number of elements that will be more fully discussed with respect to other figures. For example, the sensor fabrication device can hold a plurality of blank and/or bare electrodes 104 that can be used to manufacture a plurality of sensors.

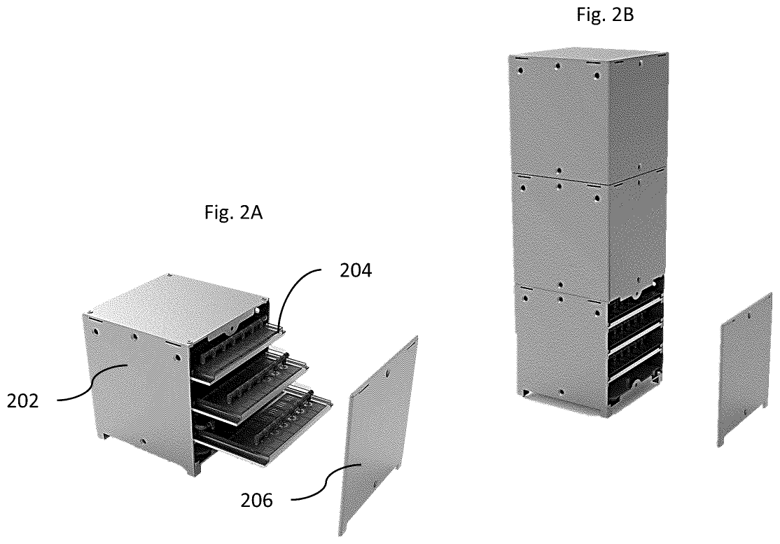

FIGS. 2A and 2B illustrate embodiments of a fabrication chamber that can be used to transport a number of sensor fabrication devices into a microgravity, low gravity and/or no gravity environment. In many embodiments, the fabrication chamber 202 can have the form factor of a specialized payload or CubeSat. Such fabrication chambers 202, can be set up to house or support a number of different independent trays 204 where each tray 204 contains a number of blank and/or bare electrodes 206. FIG. 2A illustrates an embodiment of the CubeSat form factor with three different sensor fabrication trays. In various embodiments, the fabrication chamber 202 can have removable panels 206 such that the trays 204 can be easily removed and/or inserted for use in different missions. Other embodiments can take on different configurations with more than one fabrication chambers. For example, FIG. 2B illustrates a number of fabrication chambers stacked, each of the fabrication chambers can contain a number of sensor fabrication trays.

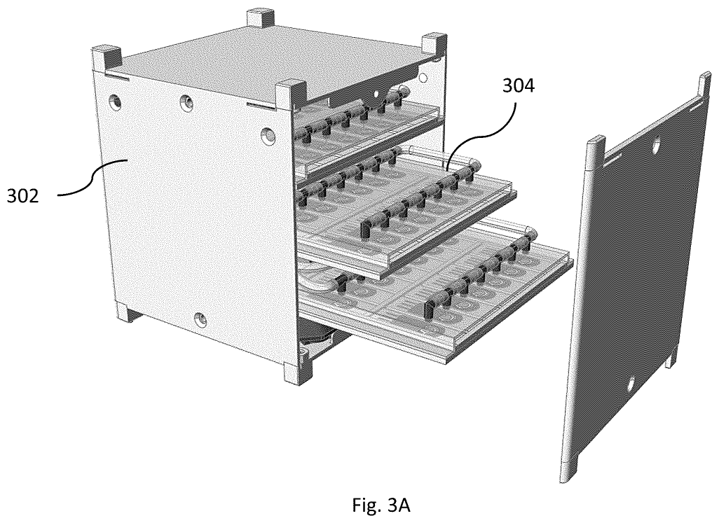

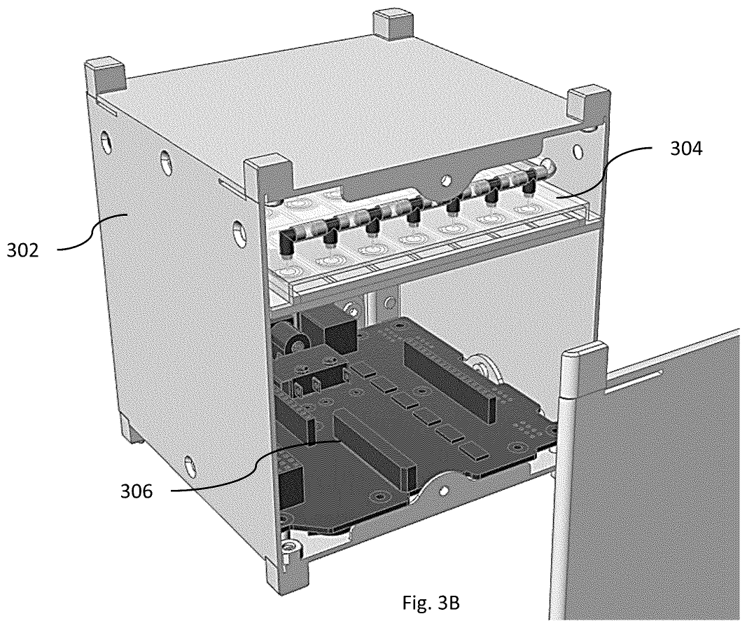

It should be readily understood that the various sensor fabrication devices can be configured to produce any number of different types of sensors and that a particular payload structure can be set up to manufacture more than one type of sensor. For example, FIGS. 3A and 3B illustrate an embodiment of a fabrication chamber 302 with a number of different sensor fabrication devices 304 enclosed within the structure 302. Each sensor fabrication system 304 can be independent and set up to deposit a different fluid on the respective blank and/or bare electrodes. Additionally, the fabrication chamber can have a control system 306 that contains a power supply system, computer controls, gravity sensors, camera control units, etc. In other words, the payload structure can house a control system 306 that is in communication with each of the sensor fabrication systems 304 and can control the flow of fluid to each of the blank and/or bare electrodes. The control system 306 can provide for a precise control of fluid to the blank and/or bare electrodes to ensure the SAM is correctly deposited. The control system 306 can utilize any suitable computer or other control devices that can be configured to control the pump and flow of fluid.

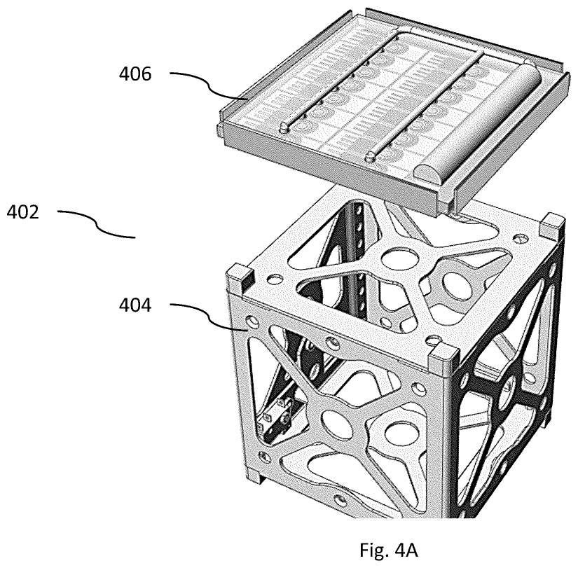

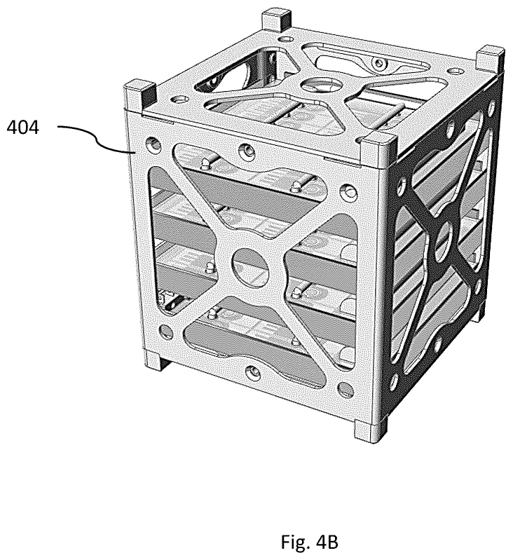

FIGS. 4A and 4B further illustrate a fabrication chamber similar to other embodiments, without any side panels. As can be appreciated the fabrication chamber 402 can have a frame structure 404 to provide structural support for the one or more sensor fabrication devices 406. Additionally, the frame structure, can provide structural support for the panels that can be installed later. This can be advantageous in allowing the panels to be removed and/or exchanged when they are damaged or if the mission has different requirements. For example, in some embodiments the panels can require a greater amount of insulation than a previous mission and therefore may require a new material to be used or a different configuration of the panel. Accordingly, many embodiments can be configured to be modular in nature and allow for the panels to be removed. This can also provide an advantage for managing the sensor fabrication elements since only one panel may need to be removed to monitor the sensor fabrication systems.

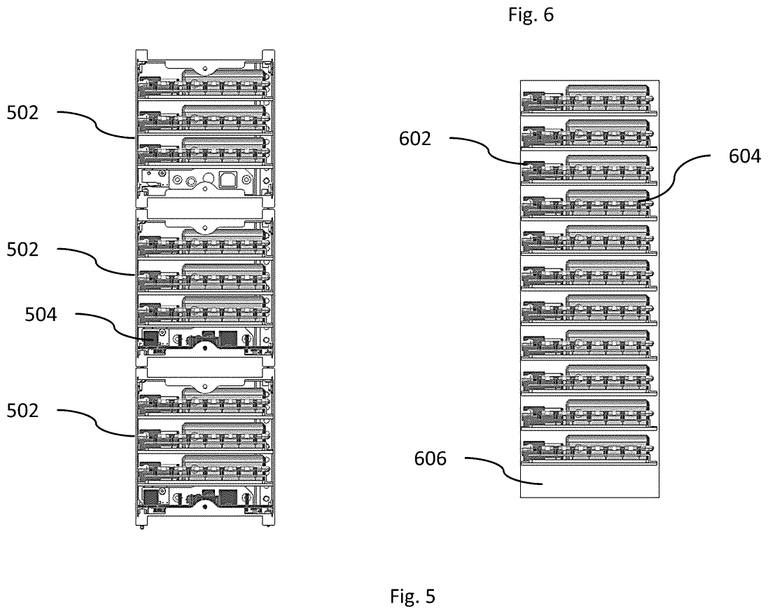

As can be appreciated, the fabrication chambers can be organized in any number of different configurations depending on the available payload of the mission. This can be more fully understood in FIGS. 5-7B, where different configurations of fabrication chambers are illustrated. For example, FIG. 5 illustrates multiple stacked fabrication chambers 502, each one containing a separate and independent control system 504.

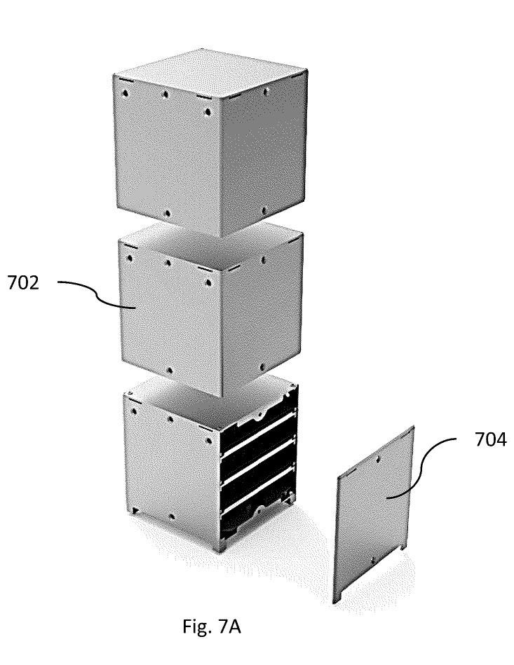

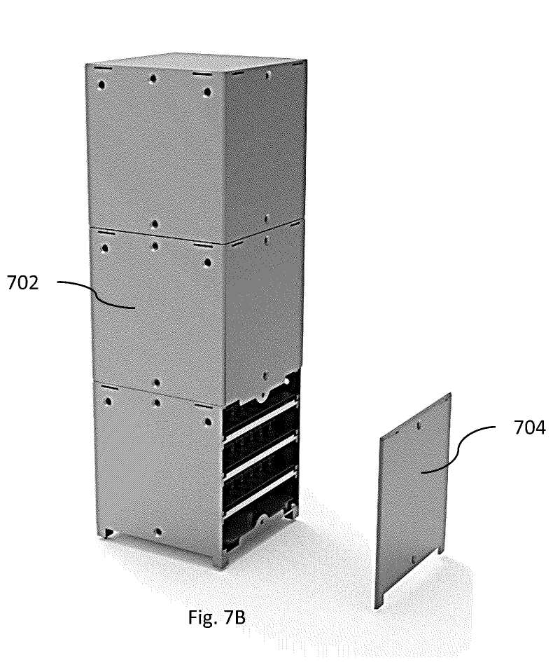

FIG. 6 illustrates another embodiment of a fabrication chamber 602 where the sensor fabrication systems 604 are contained within a single unit housing a plurality of systems 604. The single large fabrication chamber 602 can be configured with a single control system 606. The modularity of the various fabrication chambers can allow for one or more sensor to be produced since each fabrication chamber can be designed and optimized for a specific sensor. FIGS. 7A and 7B illustrate embodiments of fabrication chambers 702 with removable exterior panels 704.

### Embodiments of Sensor Fabrication Systems

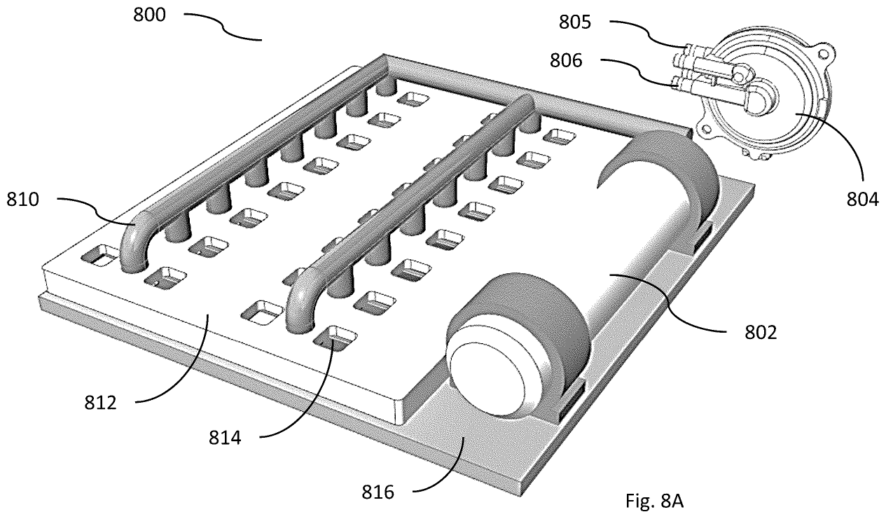

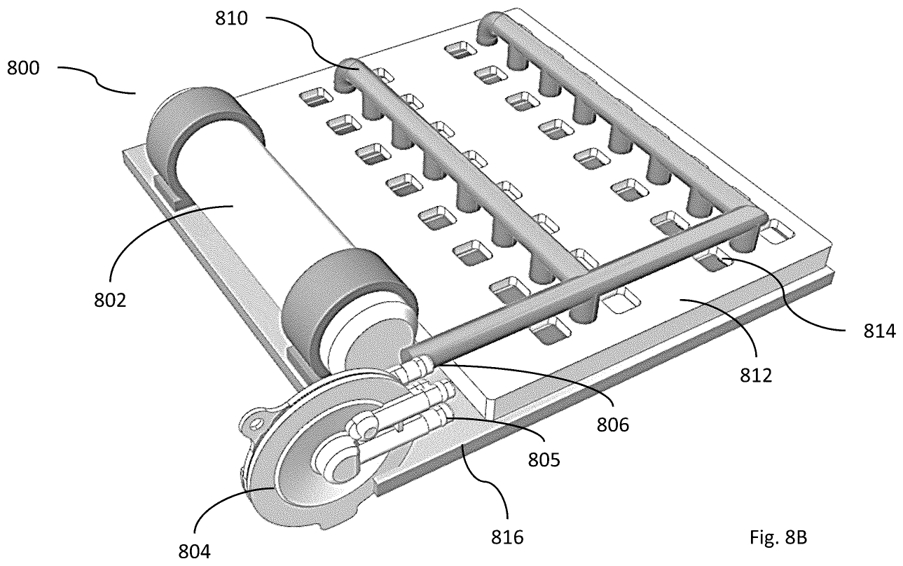

Turning now the sensor fabrication systems, FIGS. 8A through 10 illustrate various embodiments and configurations of sensor fabrication systems that can be used to manufacture various types of sensors in a microgravity, low gravity, and/or no gravity environment. In accordance with numerous embodiments, a sensor fabrication system can have a number of different components, each one optimized for precision production in microgravity, low gravity, and/or no gravity environments. For example, FIGS. 8A and 8B illustrate an embodiment of a sensor fabrication system 800 with a primary fluid reservoir 802. The fluid reservoir 802 can be configured to contain any number of chemical fluids typically used in the fabrication of sensors and more specifically for producing a SAM. For example, the reservoir 802 can house 1-ethyl-3-(-3-dimethylaminopropyl) carbodiimide hydrochloride, N-hydroxysulfo-succinimide, and/or 11-mercaptoundecanoic acid for a first layer of the SAM. Other coating agents can be used as well for subsequent applications of layers for the sensor. As can be appreciated, some embodiments of the fluid reservoir 802 may be segregated such that the reservoir can contain multiple fluids for SAM and subsequent layer production. This can be advantageous in that in longer missions multiple layers can be applied rather than a single layer per mission. Additionally, it can be appreciated that numerous configurations could allow for a complete production of layers of a sensor to be completed in the microgravity, low gravity, and/or no gravity environment.

The sensor fabrication system 800 can also have a pump 804 with at least one inlet 805 and one outlet 806 such that it can pump fluid from the reservoir 802 to a piping system 810. The piping system 810 in accordance with many embodiments can be configured to distribute fluid to a number of different blank and/or bare electrodes. In various embodiments of the system 800, a partition 812 can be placed between the piping network 810 and the electrodes. In some such embodiments, the partition 812 can have multiple openings 814 that correspond to individual blank and/or bare electrodes. Additionally, the partition 812 can help to secure the blank and/or bare electrodes to the baseplate 816. As can be appreciated, that the configuration of components of the system 800 can vary depending on the configuration and layout of the fabrication chamber for which it will be inserted. While some embodiments of the system 800 may have a square shape, others may be rectangular or any suitable shape for the fabrication chamber.

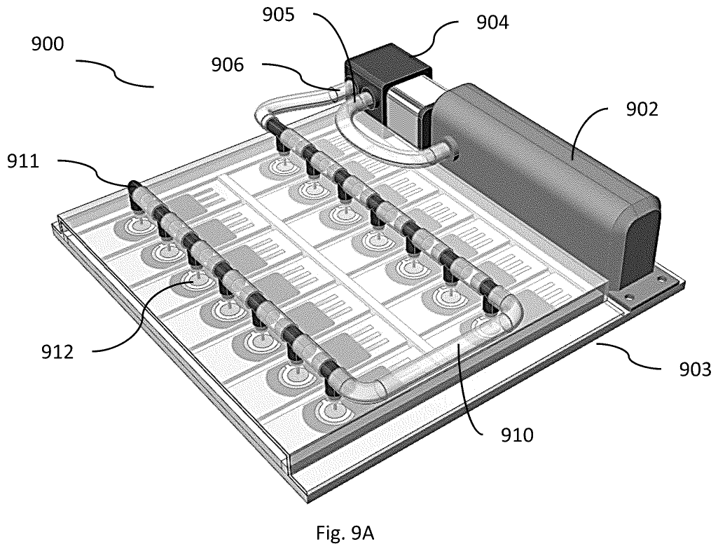

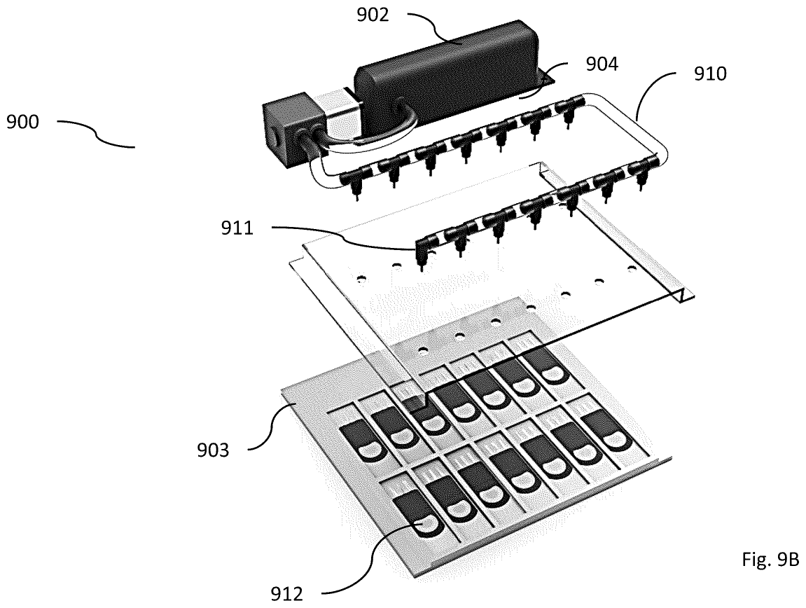

FIGS. 9A and 9B illustrate another embodiment of a sensor fabrication system 900. Similar to other embodiments, the system can have a fluid reservoir 902 that is situated on a base platform 903. Additionally, the fluid reservoir 902 can be connected to a pump 904 through any suitable connection such as a pipe or tubing. The pipe or tubing can be of any suitable material, such as plastic, rubber, metal etc. The pump 904 can be configured to pump fluid from the reservoir through an inlet 905 and push fluid out through an outlet 906. The fluid exiting the outlet 906 can then travel through a network of pipes or tubes 910 that can be distributed throughout the area of the platform 903. In accordance with various embodiments, the tubing 910 can have a number of individual dispensing elements 911. Each of the dispensing elements 911 can correspond to a blank and/or bare electrode 912.

As can be fully appreciated, the creation of highly accurate and highly sensitive sensors can be an extremely delicate process. This can be especially true when doing so in a microgravity, low gravity, or no gravity environment. Accordingly, the pressures generated by the pump 904 and the amount of fluid dispensed from the dispensing units 911 should be carefully calculated and measured to ensure the best possible SAM. Therefore, it should be understood that the pump, piping system and dispensing elements can take on any number of different configurations such that they are capable of distributing the correct amount of fluid to each of the blank and/or bare electrodes.

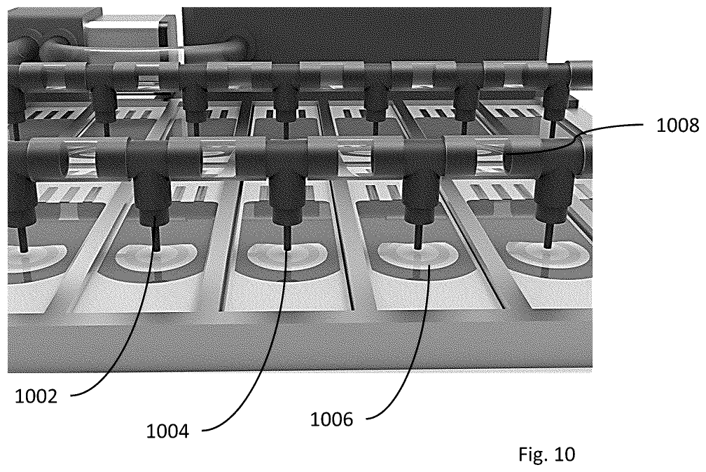

Turning now to FIG. 10 a conceptual view of a dispensing element 1002 is illustrated. In some embodiments, the dispensing element 1002 can have a pointed end 1004 much like a needle. Since the deposition of fluid in a microgravity, low gravity, or no gravity environment will rely primarily on surface tension of the fluid, the size and shape of the dispensing element 1002 and end 1004 can vary depending on the type and amount of fluid to be placed. Additionally, given the environment in which the fluid will be placed, the distance from the tip 1004 and the blank and/or bare electrode 1006 can vary. Accordingly, in many embodiments, the piping system 1008 and/or the dispensing element 1002 can be adjustable so that the overall system can be adapted to accommodate any type of suitable fluid.

As can be appreciated, the pump and associated fluid control elements can be of any suitable design and configuration such that it is capable of being controlled and can provide a precise control of fluid. This would equate to precision control of the fluid within the piping system and the deposition elements to ensure the correct amount of fluid is deposited onto the electrode blank.

The precise deposition of fluid onto the blank and/or bare electrodes can also require the deposition elements are positioned at a specific distance from the blank and/or bare electrodes. This can be critical given the sensor fabrication system will be set up to manufacture the sensors in a low or no gravity environment. Many embodiments can be configured to operate in low earth orbit. As previously stated, this system relies on the surface tension of the respective fluid to be deposited. Therefore, it should be understood that the distance between the deposition element and the electrode blank can vary from sensor to sensor. Accordingly, many embodiments may be configured to be adjustable such that each of the deposition elements can be positioned at distance respective of the fluid being deposited.

The overall specificity with which the sensor should be fabricated can require a number of different sensors to monitor the health of the system. As such, many embodiments, may have cameras to monitor the flow of fluid. Other embodiments may have telemetry sensors. As can be appreciated, the number and type of sensor can range and be adjusted depending on the overall mission requirements. Additionally, given the precision with which the sensors are to be fabricated, many embodiments may have support elements or vibrational control elements within the CubeSat structure to support each of the sensor fabrication systems during flight. This can be useful in protecting the blank and/or bare electrodes as well as the system itself since flights to low gravity environments can be turbulent. Additionally, many embodiments may be configured with insulation elements to help maintain the temperature of the sensor fabrication system for the duration of the flight and fabrication process.

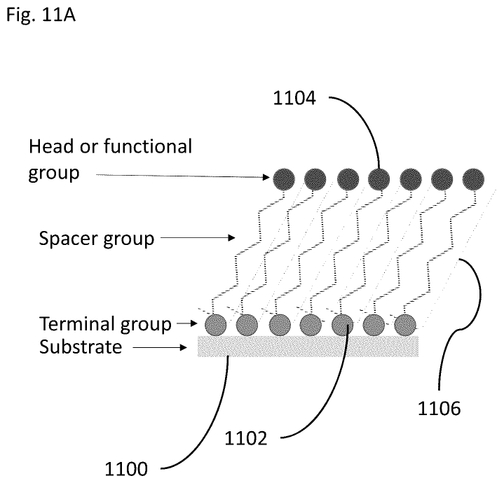

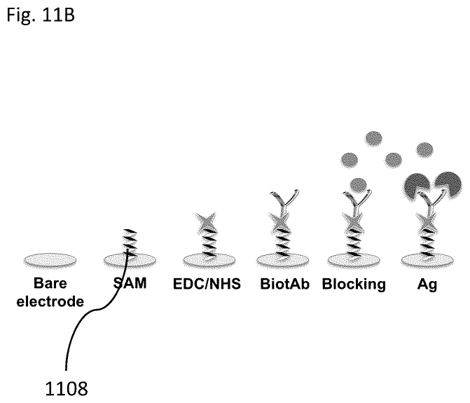

Since it can be appreciated that sensor fabrication can be highly modular and adaptable, it should be understood that the process of deposition onto the sensor substrate can vary depending on the particular application. As was previously mentioned, the deposition of a SAM can be applied to blank and/or bare electrodes or can be applied to a previously applied layer of material. For example, FIGS. 11A and 11B illustrate a process of building a SAM or the various layers of a sensor in accordance with embodiments. For example, FIG. 11A illustrates a substrate 1100 as a base component where a terminal group 1102 is applied directly to the base component 1100. The terminal group represents a terminal or end group of chemical elements that are chemically bonded to the base component 1100. The terminal group 1102 can be separated from the functional group 1104 by a spacer element 1106, or a group of chemically bonded spacer elements. As can be appreciated, the functional group 1104 can be an active group or active layer of material that interacts with external elements for detecting substances or providing an external function of the sensor. This can be illustrative of a method for producing a SAM on an electrode. FIG. 11B illustrates additional layers that can be applied on the SAM 1108 to create a functional group or functional characteristic of the sensor. Such different functional elements can allow the sensor to be fabricated for a desired purpose or to detect a specific analyte. Ultimately the external or functional group can act as an immobilization surface for any number of components such as polymers, chemicals, logical components, (oligo-) nucleotides, proteins, antibodies, and receptors.

As can be fully appreciated, the sensor fabrication system can be highly modular and adaptable to a number of different fluids as well as different scenarios to consider the change in environment from earth to space. Accordingly, the embodiments illustrated herein are not intended to be exhaustive of the various embodiments that can be used.

### Sensor Fabrication Modules and Associated Systems

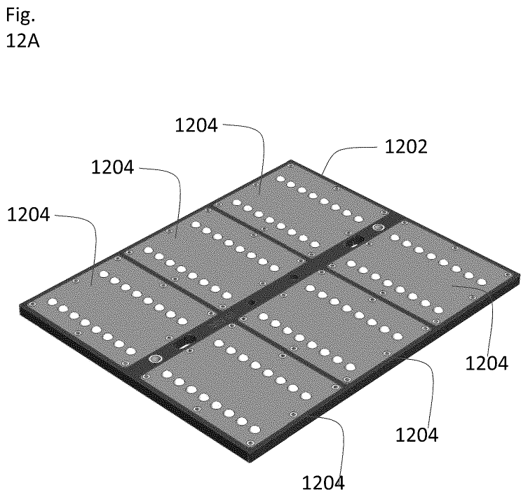

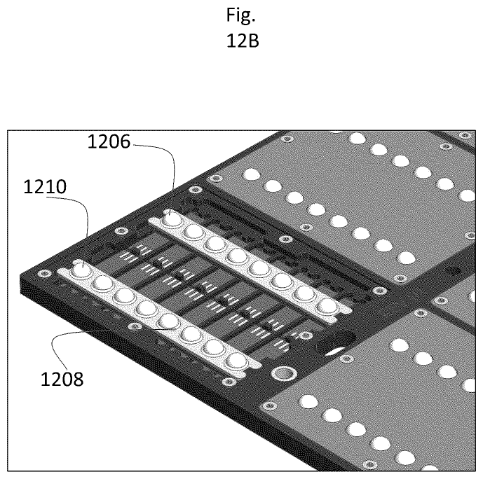

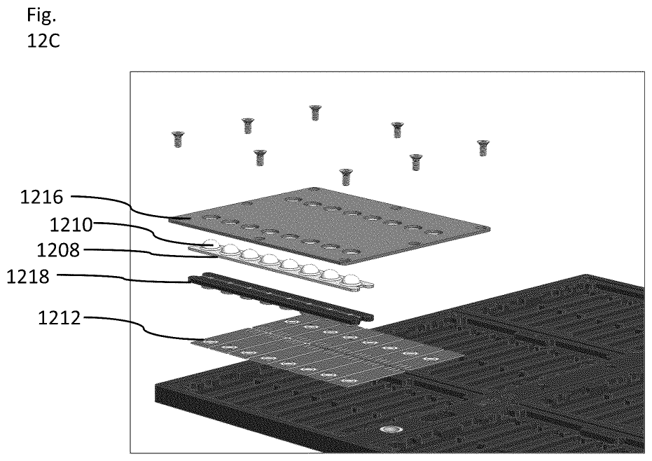

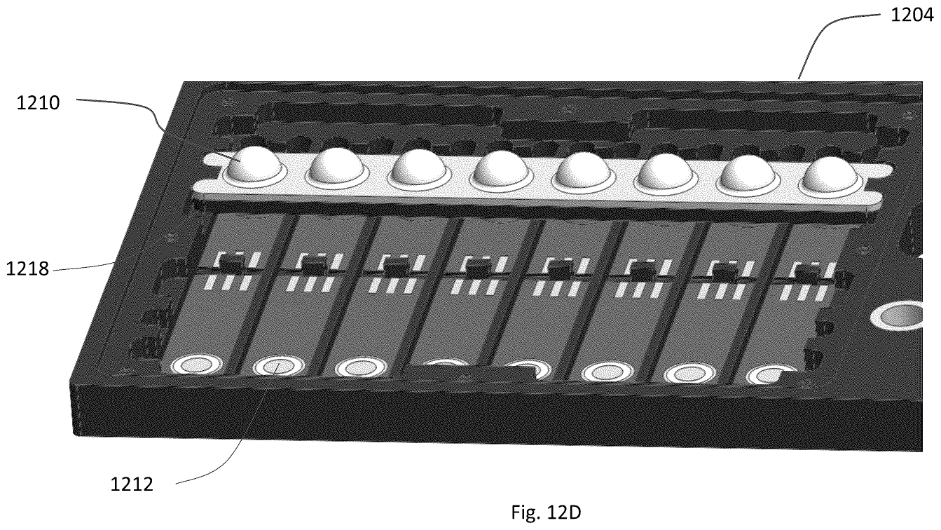

In many embodiments, a space-based sensor fabrication system can utilize the dominant force of surface tension to apply a layer of material to an electrode. This can result in creating a more uniform SAM for improved sensing and performance as compared with conventional methods. Many embodiments can be configured to fit within a small form factor such as a CubeSat forming a fabrication chamber. An example of a sensor fabrication element is conceptually illustrated in FIGS. 12A through 12D. A sensor fabrication tray 1202 can be housed within a CubeSat form factor or any other suitable payload transportation element. The sensor fabrication tray 1202 can include sensor fabrication modules 1204. The sensor fabrication modules can include fluid dispensing systems 1206. Each fluid dispensing system 1206 can include a strip 1208 with a series of fluid reservoirs 1210 arranged along a length of the strip 1208. Each fluid reservoir 1210 can correspond to one or more of one or more blank and/or bare electrodes 1212. FIG. 12C shows an exploded view with various hidden portions. FIG. 12D shows a view with some portions hidden to make the electrodes 1212 more clearly seen. The blank and/or bare electrodes can be suitable to be used to manufacture a plurality of sensors. While the fabrication tray 1202 includes six fabrication modules 1204, a fabrication tray can include any suitable number and/or arrangement of fabrication modules. While fabrication modules 1204 include two fluid dispensing systems 1206, a fabrication module can include any suitable number and/or arrangement of fluid dispensing systems. While fluid dispensing systems 1206 include eight fluid reservoirs 1210 each, a fluid dispensing system can include any suitable number and/or arrangement of fabrication modules. Each electrode 1212 can be arranged on a first side of a fluid reservoir 1210. The first side can be opposite a second side of the fluid reservoir 1210, the second side facing towards (e.g., in contact with) a top plate 1216 of a module 1204. The fluid dispensing system 1206 can include a nozzle component 1218. Nozzle components can include a nozzle for each reservoir 1210. The nozzle component can be arranged between the strip 1208 and the electrodes 1212. The reservoir 1210 and the nozzle component 1218 are configured to dispense a fluid onto the electrode 1212 when a force is applied to the reservoir 1210. The strip 1208 can hold the reservoirs 1210 in a generally fixed position relative to the tray 1202. In various embodiments, reservoirs are configured to dispense a fluid onto electrodes in response to an external force applied onto the reservoirs. The reservoirs can deform in response to the external force. The deformation can cause the fluid to be dispensed.

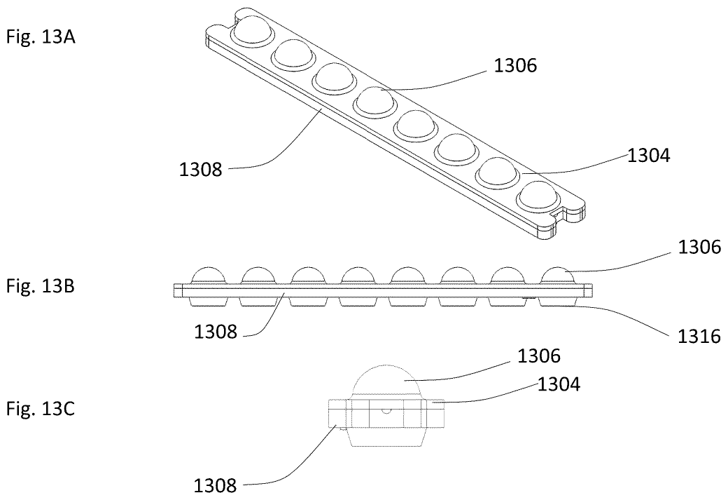

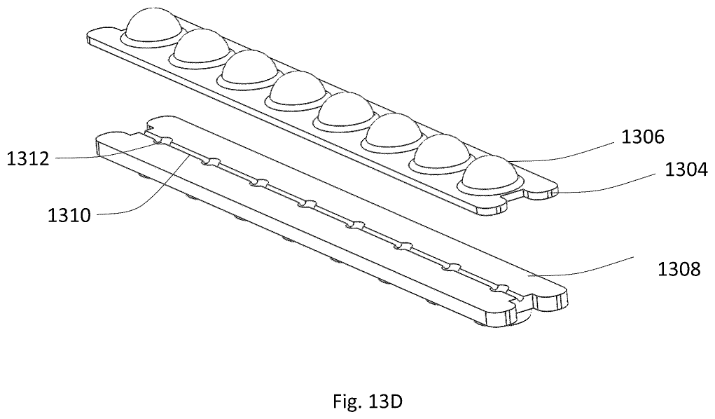

A fluid dispensing system is conceptually illustrated in FIGS. 13A through 13D. The fluid dispensing system 1302 includes a strip 1304. In some embodiments, a strip (e.g., strip 1304) can provide mechanical strength. The strip 1304 can include reservoirs 1306. The strip can be configured with passages connecting the reservoirs 1306 to the nozzle component 1308. The nozzle component 1308 can include an inner channel 1310. Each reservoir 1306 can correspond to a nozzle passage 1312. The nozzle passages 1312 can be aligned to the inner channel 1310. The inner channel 1310 and the nozzle passages 1312 can be in fluid communication. This can be beneficial to allow for easy loading of the liquid prior to fabrication. The nozzle passages can conduct fluid from the reservoirs and onto electrodes. The nozzle passages can lead to nozzle outlets 1316.

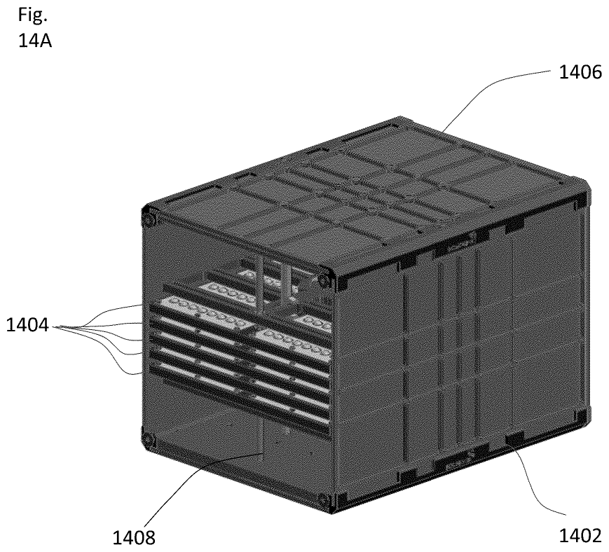

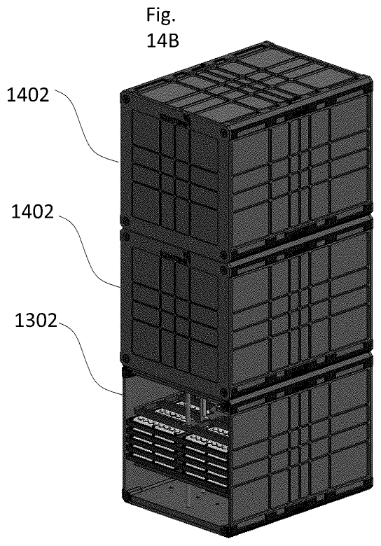

A fabrication chamber with a number of sensor fabrication devices is conceptually illustrated in FIGS. 14A through 14B. In several embodiments, sensor fabrication devices can function in a microgravity, low gravity and/or no gravity environment. A fabrication chamber 1402 can have the form factor of a CubeSat. fabrication chambers 1402, can be set up to house or support a number of different sensor fabrication trays 1404. fabrication trays can be independent trays. Each fabrication tray 1404 can contain a number of blank and/or bare electrodes.

FIG. 14A illustrates a payload form factor with five different sensor fabrication trays 1404. The fabrication chamber 1402 can have removable panels 1406 such that the trays 1404 can be removed and/or inserted for use in different missions. In various embodiments, different configurations can be used with more than one fabrication chamber. An example of a number of fabrication chambers 1402 stacked together is conceptually illustrated in FIG. 14B. Each of the fabrication chambers 1402 can contain a number of sensor fabrication trays 1404.

In several embodiments, the various sensor fabrication devices can be configured to produce any number of different types of sensors and that a particular payload structure can be set up to manufacture more than one type of sensor. A fabrication chamber 1402 can have a number of different sensor fabrication trays 1404 enclosed within the structure of the fabrication chamber 1402. Each sensor fabrication tray 1404 can be independent and set up to deposit a different fluid on the respective blank and/or bare electrodes. Additionally, the fabrication chamber can have a control system. Control systems can include power supply systems, computer controls, gravity sensors, camera control units, etc. In accordance with various embodiments of the invention, control systems can provide control of fluid to the blank and/or bare electrodes to ensure the SAM is correctly deposited. The control system can utilize any suitable SBC (Single Board Computer) or other control devices that can be configured to control a flow of fluid. Furthermore, each fabrication chamber can be configured with a reservoir pressurizing system. The fabrication chamber 1402 includes a reservoir pressurizing system 1408. The reservoir pressurizing system 1408 can use motors to apply a mechanical force to at least one of (e.g., all) the reservoirs included within the sensor fabrication modules (e.g., as described in relation to FIG. 12) included on the fabrication trays 1404. Reservoir pressurizing systems are discussed in more detail elsewhere herein.

In several embodiments, a fabrication chamber can contain at least one sensor fabrication tray (e.g., sensor fabrication tray 1404). Each sensor fabrication tray can include at least one sensor fabrication module. Each sensor fabrication module can include at least one fluid dispensing system. Each fluid dispensing system can have at least one fluid reservoir. Each fluid reservoir can correspond to an electrode.

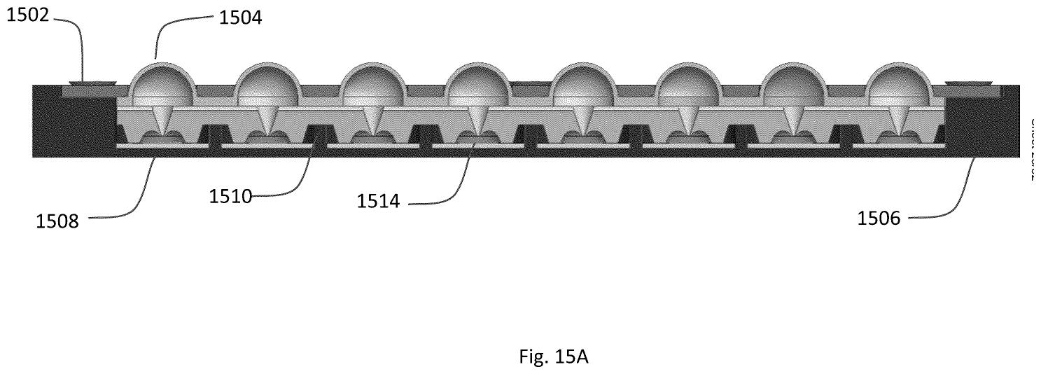

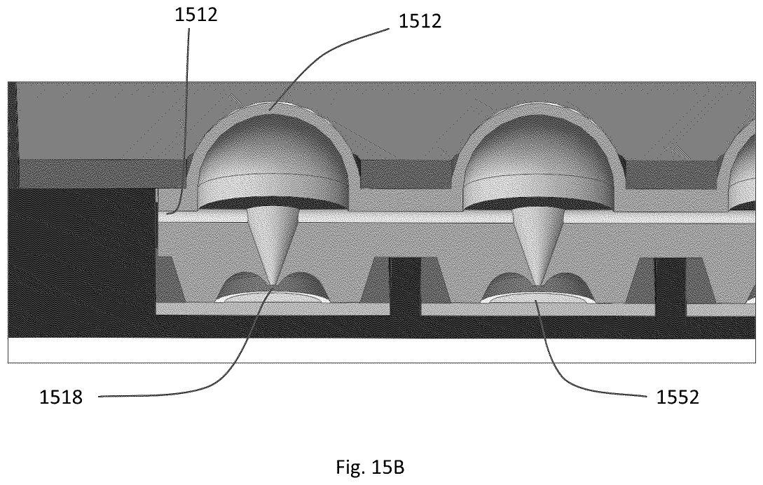

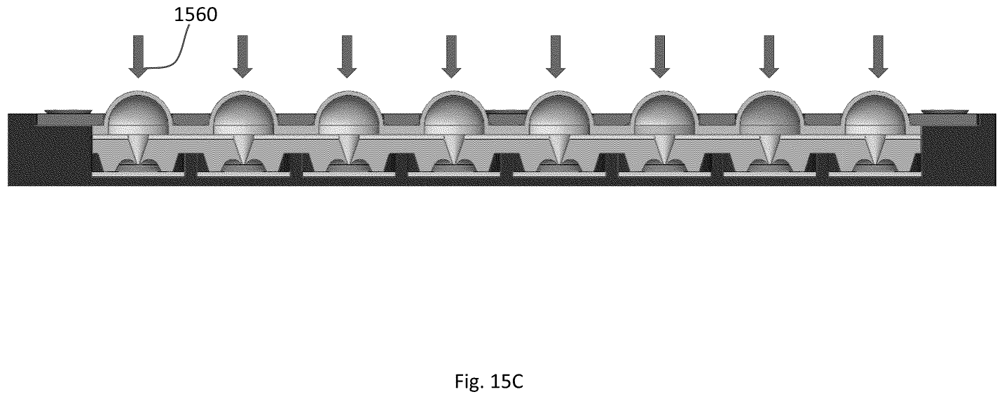

In accordance with numerous embodiments, a sensor fabrication system, and/or associated sensor fabrication modules can have a number of different components, each one optimized for precision production in microgravity, low gravity, and/or no gravity environments. A cross-section view of an example fluid dispensing system is conceptually illustrated in FIG. 15. A through C. A fluid dispensing system 1502 can include reservoirs 1504. Fluid reservoirs can be configured to contain any number of chemical fluids typically used in the fabrication of sensors (e.g., for producing a SAM). In accordance with various embodiments of the invention, reservoirs can house 1-ethyl-3-(-3-dimethylaminopropyl) carbodiimide hydrochloride, N-hydroxysulfo-succinimide, and/or 11-mercaptoundecanoic acid for a first layer of the SAM. Other coating agents can be used as well for subsequent applications of layers for the sensor. As can be appreciated, some embodiments of the fluid reservoir can be segregated such that the reservoir can contain multiple fluids for SAM and subsequent layer production. This can be advantageous in that in longer missions multiple layers can be applied rather than a single layer per mission. Additionally, it can be appreciated that numerous configurations could allow for a complete production of layers of a sensor to be completed in the microgravity, low gravity, and/or no gravity environment.

The fluid dispensing system 1502, and other similar fluid dispensing systems in accordance with many embodiments can be configured to distribute fluid to a number of different blank and/or bare electrodes. In some such embodiments, a baseplate 1506 can have multiple openings 1508. Each of the openings 1508 can correspond to individual blank and/or bare electrodes. In several embodiments, a partition 1510 can help to secure the blank and/or bare electrodes to the baseplate 1506. The partition 1510 can separate the electrodes. As can be appreciated, the configuration of components of a fluid dispensing system (e.g., fluid dispensing system 1502) can vary depending on the configuration and layout of the fabrication chamber for which it will be inserted. In some embodiments, a fluid dispensing system can a square shape, a rectangular shape, or any suitable shape for the fabrication chamber.

The fluid dispensing system 1502 can include at least one reservoir 1504. The reservoir 1504 can have a flexible dome 1512. The flexible dome 1512 of a reservoir can be used to drive the fluid through an outlet nozzle 1514. When the flexible dome 1512 is depressed, fluid contained in the dome can be pushed through the outlet nozzle 1514. The nozzle walls section 1516 additionally can provide a containment layer to the fluid. It should be understood that, in various embodiments, the fluid reservoir and the other fluid dispensing system elements can take on any number of different configurations such that they are capable of distributing the correct amount of fluid to each of the blank and/or bare electrodes.

A close view of a fluid dispensing system is provided in FIG. 15B. A fluid dispensing system 1502 can include a dispensing element 1518. The dispensing element can have a pointed end much like a needle. Since the deposition of fluid in a microgravity, low gravity, or no gravity environment, the deposition relies primarily on surface tension of the fluid. The size and shape of the dispensing element 1518 can vary depending on the type and amount of fluid is to be placed. Additionally, given the environment in which the fluid will be placed, the distance from the tip 1518 and the blank and/or bare electrode 1552 can vary. The fluid dispensing system can further include a height control structure 1520. The height control structure adjustable so that the overall system can be adapted (e.g., distance between tip 1518 and electrode 1552) to accommodate any type of suitable fluid.

FIG. 15C shows how a force 1560 can be applied to one or more of the reservoirs 1504. In some embodiments, a press mechanism can exert an around equal force to all the reservoirs 1504 simultaneously. The press mechanism is described in great detail below.

In accordance with numerous embodiments of the invention, the fluid dispensing structure elements can be of any suitable design and configuration such that it is capable of being controlled and can provide a precise control of fluid. This can equate to precision control of the fluid within the reservoir and the deposition elements to ensure the correct amount of fluid is deposited onto an electrode blank.

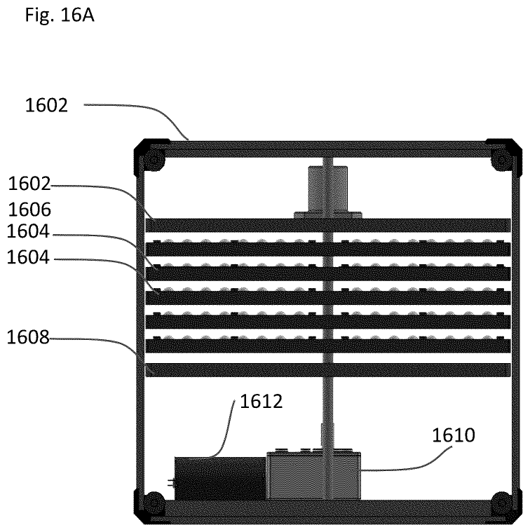

The creation of highly accurate and highly sensitive sensors can be an extremely delicate process. This can be especially true when doing so in a microgravity, low gravity, or no gravity environment. Accordingly, the pressure generated by the press mechanism and the amount of fluid dispensed from the fluid dispensing systems should be calculated and measured to ensure the best possible SAM. An example of a fabrication chamber with press mechanism is conceptually illustrated in FIG. 16A through B. A fabrication chamber 1602 can include a number (e.g., 5) fabrication trays 1604 arranged between two plates 1606, 1608. The plates 1606 and 1608 can translate towards each other. The fabrication trays can be moved towards each other by the plates 1606 and 1608. The pressure of the plates 1606 and 1608 can deform the flexible domes of reservoirs. The reservoirs forming a part of the trays 1604. When the reservoirs are deformed they deposit their contents on electrodes to perform a sensor manufacturing process. The translation of the plates 1606 can be controlled by a motor 1610 and a control system 1612. In various embodiments the configuration of the plates and/or motors can be changes. A press mechanism includes those components used for subjecting a reservoir to force tending to dispense the reservoir. A press mechanism can include a motor, a control system, and a moving component (e.g., one or more plates) for subjecting the reservoirs to a force. FIG. 16B shows the fabrication chamber with the cross section going through the nozzles of the trays. The press mechanism can include a control system, a motor, and/or movable components. In some embodiments the press mechanism can have two movable components (e.g., plates), and/or two motors.

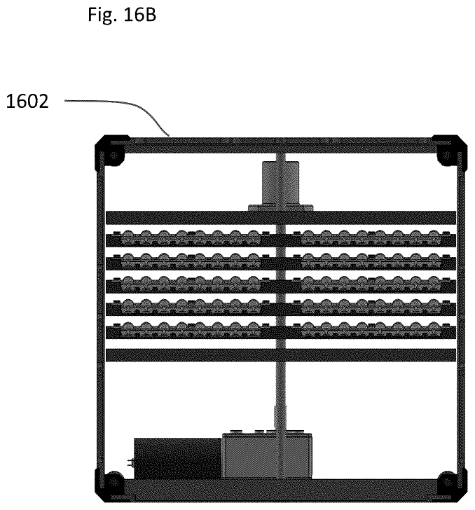

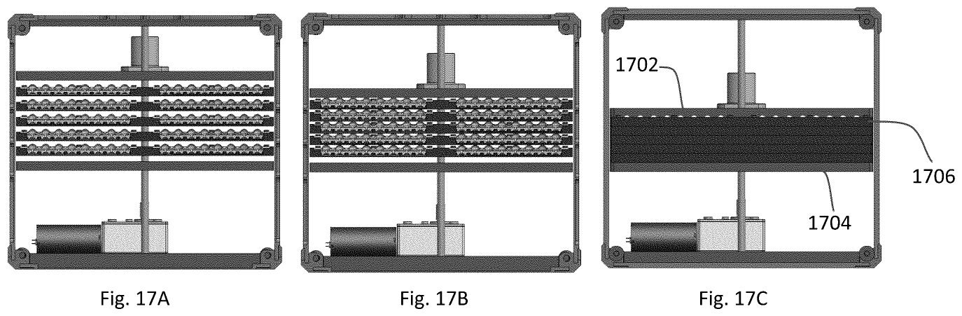

An example of a manufacturing process being performed by a fabrication chamber is conceptually illustrated in FIGS. 17A through 17C. As can be seen, the plates 1702, 1704 move towards each other and/or displace the trays 1706 to dispense the fluid onto the electrodes to perform the manufacturing process.

In several embodiments, the precise deposition of fluid onto the blank and/or bare electrodes can also require the deposition elements are positioned at a specific distance from the blank and/or bare electrodes. This can be critical given the sensor fabrication system will be set up to manufacture the sensors in a low or no gravity environment. Many embodiments can be configured to operate in low earth orbit. As previously stated, some embodiments rely on the surface tension of the respective fluid to be deposited. Therefore, in several embodiments, the distance between the deposition element and the electrode blank can vary from sensor to sensor. Accordingly, many embodiments may be configured to be adjustable such that each of the deposition elements can be positioned at distance respective of the fluid being deposited.

In accordance with many embodiments of the invention, a nozzle can be positioned relative to the electrode such that a fluid dispensed by the fluid dispensing system is subjected to sufficient surface tension forces to hold the dispensed fluid in place and in contact with the electrode. The positioning can vary depending on the nozzle characteristics and/or the fluid characteristics. A fluid dispensing system can, in some embodiments, use surface tension to apply a layer of material to an electrode. The distance between the nozzle and the electrode (e.g., bar electrode) can be selected such that surface tension of the fluid is sufficient to hold the fluid on the electrode.

The overall specificity with which the sensor should be fabricated can require a number of different sensors to monitor the health of the system. As such, many embodiments can include cameras to monitor the flow of fluid. Other embodiments may have telemetry sensors. As can be appreciated, the number and type of sensor can range and be adjusted depending on the overall mission requirements. Additionally, given the precision with which the sensors are to be fabricated, many embodiments may have support elements or vibrational control elements within the CubeSat structure to support each of the sensor fabrication systems during flight. This can be useful in protecting the blank and/or bare electrodes as well as the system itself since flights to low gravity environments can be turbulent. Additionally, many embodiments can be configured with insulation elements to help maintain the temperature of the sensor fabrication system for the duration of the flight and fabrication process.

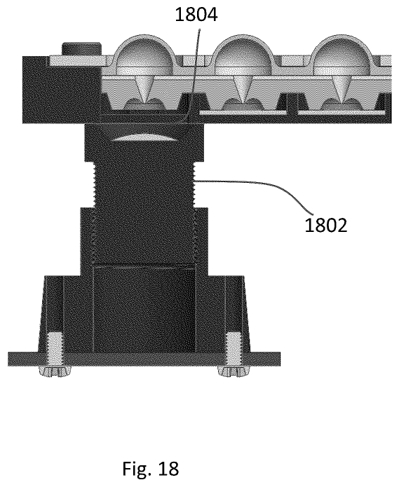

An example of a camera mounted to observe a deposition site is conceptually illustrated in FIG. 18. A camera 1802 can be used to observe a deposition site 1804. In various embodiments, the camera be configured and/or positioned to observe an amount (e.g., volume), speed and/or deposition pattern of a fluid drop as applied to an electrode. In this way, several embodiments can monitor how a fabrication process is being performed. This information can then be used in improving future fabrications.

As can be fully appreciated, the sensor fabrication system can be highly modular and adaptable to a number of different fluids as well as different scenarios to consider the change in environment from earth to space. Accordingly, the embodiments illustrated herein are not intended to be exhaustive of the various embodiments that can be used.

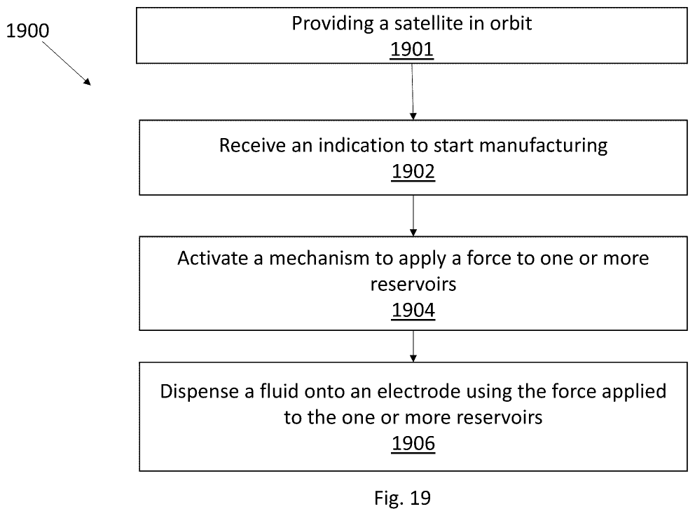

An example process for space-based sensor fabrication is conceptually illustrated in FIG. 19. A process 1900 can include providing (1901) a satellite in space. Providing a satellite in space can involve launching a satellite into orbit. The process 1900 can include receiving (1902) an indication to start manufacturing. The process 1900 can activate (1904) a press mechanism to apply a force to one or more reservoirs. The process 1900 can thereby dispense (1906) a fluid onto an electrode using the force applied to the one or more reservoirs. The flow the fluid can be controlled, in various embodiments, by relying on surface tension. This can be especially important is space-based manufacturing since gravity is reduced. In several embodiments, the dispensing of the fluid onto the electrode can be part of a chemical deposition process to create a self-assembled monolayer. The chemical deposition process can include obtaining a bare surface (e.g., on an electrode) for the application of a chemical substance. The chemical process can then be applied (e.g., when the fluid is dispensed from the reservoir). Additionally, a chemical deposition process can include applying a head group chemical to the bare surface, and/or applying a functional tail group to a head group, wherein a functional group is configured to operate or interact with an external element thereby causing a reaction. In accordance with embodiments of the invention, a chemical deposition process can further include applying a spacer group between the head group and the functional tail group. A functional tail group can further serve as a functionalized surface for an immobilization of a group consisting of polymers, chemicals, biological components, (oligo-) nucleotides, proteins, antibodies, and/or receptors.

### Exemplary Embodiments

A first embodiment including: a fluid dispensing system, the fluid dispensing system including at least one reservoir, and at least one nozzle, wherein each nozzle corresponds to a reservoir; at least one electrode; and a press mechanism, the press mechanism capable of applying an external force on at least one of the at least one reservoir; wherein the at least one reservoir dispenses a fluid onto the at least one electrode in response to the external force applied.

A second embodiment including the features of the first embodiment and wherein the at least one reservoir is deformed in response to the external force applied, and the deformation causes the fluid to be dispensed.

A third embodiment including the features of any of the first through second embodiment and wherein the press mechanism includes a control system, a motor, and a movable component.

A fourth embodiment including the features of any of the first through third embodiment and wherein the press mechanism includes a first plate and a second plate.

A fifth embodiment including the features of any of the first through fourth embodiment and wherein the press mechanism includes a first plate, a second plate, and a second fluid dispensing, and wherein the first fluid dispensing system and the second fluid dispensing system are arranged in series between the first plate and the second plate.

A sixth embodiment including the features of any of the first through fifth embodiment and wherein the press mechanism includes a first plate, a second plate, and a second fluid dispensing, and wherein the first fluid dispensing system and the second fluid dispensing system are arranged in series between the first plate and the second plate.

A seventh embodiment including the features of any of the first through sixth embodiment and wherein the sensor fabrication system is capable of manufacturing a self-assembled monolayer.

An eighth embodiment including the features of any of the first through seventh embodiment and wherein the at least one reservoir includes a first reservoir and a second reservoir, the at least one nozzle includes a first nozzle and a second nozzle, and the at least one electrode includes a first electrode and a second electrode.

A ninth embodiment including the features of any of the first through eighth embodiment and wherein the reservoir has a flexible top.

A 10^{th} embodiment including the features of any of the first through ninth embodiment and wherein a distance between a reservoir tip and the at least one electrode is adjustable.

An 11^{th} embodiment including the features of any of the first through 10^{th} embodiment and wherein a nozzle positioning relative to the electrode is configured such that a fluid dispensed by the fluid dispensing system is subjected to sufficient surface tension forces to hold the dispensed fluid in place and in contact with the electrode.

An 12^{th} embodiment including the features of any of the first through 11^{th} embodiment and wherein the fluid dispensing system uses surface tension to apply a layer of material to an electrode.

An 13^{th} embodiment including the features of any of the first through 12^{th} embodiment and wherein a distance between the nozzle and the electrode is selected such that surface tension of the fluid is sufficient to hold the fluid on the at least one electrode.

A 14^{th} embodiment including: an outer wall; a press mechanism; at least one fabrication tray; at least one fabrication module coupled to the at least one fabrication tray; and at least one electrode; wherein the fabrication module dispenses a fluid onto the at least one electrode in response to a force applied by the press mechanism.

A 15^{th} embodiment including the features of the 14^{th} embodiment and wherein the outer wall conforms to a CubeSat form factor.

A 16^{th} embodiment including the features of any of the 14^{th} through 15^{th} embodiment and wherein the at least one fabrication module includes: a fluid dispensing system, the fluid dispensing system including at least one reservoir, and at least one nozzle, wherein each nozzle corresponds to a reservoir; at least one electrode; and a press mechanism, the press mechanism capable of applying an external force on at least one of the at least one reservoir; wherein the at least one reservoir dispenses a fluid onto the at least one electrode in response to the external force applied.

A 17^{th} embodiment including the features of any of the 14^{th} through 16^{th} embodiment and wherein the at least one fabrication tray is two or more fabrication trays.

A 18^{th} embodiment including the features of any of the 14^{th} through 17^{th} embodiment and wherein the at least one fabrication tray is five fabrication trays.

A 19^{th} embodiment including the features of any of the 14^{th} through 18^{th} embodiment and wherein the at least one fabrication module is two or more fabrication modules per fabrication tray.

A 20^{th} embodiment including the features of any of the 14^{th} through 19^{th} embodiment and wherein the at least one fabrication tray is six fabrication modules per fabrication tray.

A 21^{st} embodiment including the features of any of the 14^{th} through 20^{th} embodiment and wherein the press mechanism can apply a force to all reservoirs in a sensor fabrication chamber simultaneously.

A 22^{nd} embodiment including the features of any of the 14^{th} through 21^{st} embodiment and wherein the at least one reservoir is deformed in response to the external force applied, and the deformation causes the fluid to be dispensed.

A 23^{rd} embodiment including the features of any of the 14^{th} through 22^{nd} embodiment and wherein the press mechanism includes a control system, a motor, and a movable component.

A 24^{th} embodiment including the features of any of the 14^{th} through 23^{rd} embodiment and wherein the press mechanism includes a first plate and a second plate.

A 25^{th} embodiment including the features of any of the 14^{th} through 24^{th} embodiment and wherein the press mechanism includes a first plate, a second plate, and a second fluid dispensing, and wherein the first fluid dispensing system and the second fluid dispensing system are arranged in series between the first plate and the second plate.

A 26^{th} embodiment including the features of any of the 14^{th} through 25^{th} embodiment and wherein the press mechanism includes a first plate, a second plate, and a second fluid dispensing, and wherein the first fluid dispensing system and the second fluid dispensing system are arranged in series between the first plate and the second plate.

A 27^{th} embodiment including the features of any of the 14^{th} through 26^{th} embodiment and wherein the sensor fabrication system is capable of manufacturing a self-assembled monolayer.

A 28^{th} embodiment including the features of any of the 14^{th} through 27^{th} embodiment and wherein the at least one reservoir includes a first reservoir and a second reservoir, the at least one nozzle includes a first nozzle and a second nozzle, and the at least one electrode includes a first electrode and a second electrode.

A 29^{th} embodiment including the features of any of the 14^{th} through 28^{th} embodiment and wherein the reservoir has a flexible top.

A 30^{th} embodiment including the features of any of the 14^{th} through 29^{th} embodiment and wherein a distance between a reservoir tip and the at least one electrode is adjustable.

A 31^{st} embodiment, including: a baseplate; a fluid reservoir disposed on a top surface of the baseplate; a pump in fluid communication with the fluid reservoir wherein the pump has at least one inlet and one outlet, where the inlet is configured to receive fluid from the fluid reservoir; and a network of tubing connected to the at least one outlet and in fluid communication with the pump, wherein the network of tubing is disposed above the top surface of the baseplate and configured to dispense fluid through a plurality of fluid dispensing elements by surface tension application; wherein each of the plurality of fluid dispensing elements corresponds to at least one blank and/or bare electrode, wherein each of the at least one blank and/or bare electrode is disposed on the top surface of the baseplate.

A 32^{nd} embodiment including: A plurality of sensor fabrication systems, wherein each of the plurality of sensor fabrication systems includes: a baseplate; a fluid reservoir disposed on a top surface of the baseplate; a pump in fluid communication with the fluid reservoir wherein the pump has at least one inlet and one outlet, where the inlet is configured to receive fluid from the fluid reservoir; and a network of tubing connected to the at least one outlet and in fluid communication with the pump, wherein the network of tubing is disposed above the top surface of the baseplate and configured to dispense fluid through a plurality of fluid dispensing elements by surface tension application; wherein each of the plurality of fluid dispensing elements corresponds to at least one blank and/or bare electrode, wherein each of the at least one blank and/or bare electrode is disposed on the top surface of the baseplate; and at least one control module, wherein the at least one control module is configured to control a functioning of each of the plurality of sensor fabrication systems.

A 33^{rd} embodiment includes: obtaining a bare surface for an application of a chemical substance; applying a head group chemical to the bare surface; applying a functional tail group to a head group, wherein a functional group is configured to operate or interact with an external element thereby causing a reaction.

A 34^{th} embodiment including all the aspects of the 33^{rd} embodiments and further including applying a spacer group between the head group and the functional tail group.

A 35^{th} embodiment including the features of any of the 33^{rd} through 36^{th} embodiment and wherein the functional tail group further serves as a functionalized surface for an immobilization of a group consisting of polymers, chemicals, logical components, (oligo-) nucleotides, proteins, antibodies, and receptors.

A 36^{th} embodiment including: a baseplate; and a fluid dispensing structure disposed on a top surface of the baseplate that has a flexible portion that serves as a fluid reservoir and dispensing nozzle. The structure has at least one inlet to load the fluid and one outlet to dispense; wherein each of a plurality of fluid dispensing elements corresponds to at least one blank and/or bare electrode, wherein each of the at least one blank and/or bare electrode is disposed on the top surface of the baseplate.

A 37^{th} embodiment including: A plurality of sensor fabrication systems, wherein each of the plurality of sensor fabrication systems includes: a baseplate; a fluid dispensing structure disposed on a top surface of the baseplate that has a flexible some that serves as a fluid reservoir and dispensing nozzle. The structure has at least one inlet to load the fluid and one outlet to dispense; wherein each of a plurality of fluid dispensing elements corresponds to at least one blank and/or bare electrode, wherein each of the at least one blank and/or bare electrode is disposed on the top surface of the baseplate; and at least one control module, wherein the at least one control module is configured to control a functioning of each of the plurality of sensor fabrication systems.

A 38^{th} embodiment including: providing a satellite in orbit; activating a press mechanism to apply an external force on at least one reservoir; wherein the at least one reservoir dispenses a fluid through at least one nozzle onto an at least one electrode in response to the external force applied.

A 39^{th} embodiment including all the features of the 38^{th} embodiment and wherein the at least one reservoir is deformed in response to the external force applied, and the deformation causes the fluid to be dispensed.

A 41^{st} embodiment including the features of any of the 38^{th} through 40^{th} embodiment and wherein the press mechanism includes a control system, a motor, and a movable component.

A 42^{nd} embodiment including the features of any of the 38^{th} through 41^{st} embodiment and wherein the press mechanism includes a first plate and a second plate.

A 43^{rd} embodiment including the features of any of the 38^{th} through 42^{nd} embodiment and wherein the press mechanism includes a first plate, a second plate, and a second fluid dispensing, and wherein the first fluid dispensing system and the second fluid dispensing system are arranged in series between the first plate and the second plate.

A 44^{th} embodiment including the features of any of the 38^{th} through 43^{rd} embodiment and wherein the press mechanism includes a first plate, a second plate, and a second fluid dispensing, and wherein the first fluid dispensing system and the second fluid dispensing system are arranged in series between the first plate and the second plate.

A 45^{th} embodiment including the features of any of the 38^{th} through 44^{th} embodiment and wherein the method for space-based sensor fabrication is capable of manufacturing a self-assembled monolayer.

A 46^{th} embodiment including the features of any of the 38^{th} through 45^{th} embodiment and wherein the at least one reservoir includes a first reservoir and a second reservoir, the at least one nozzle includes a first nozzle and a second nozzle, and the at least one electrode includes a first electrode and a second electrode.

A 47^{th} embodiment including the features of any of the 38^{th} through 46^{th} embodiment and wherein the reservoir has a flexible top.

A 48^{th} embodiment including the features of any of the 38^{th} through 47^{th} embodiment and wherein a distance between a reservoir tip and the at least one electrode is adjustable.

A 49^{th} embodiment including the features of any of the 38^{th} through 48^{th} embodiment and wherein a positioning of the at least one nozzle relative to the at least one electrode is configured such that a fluid dispensed by a fluid dispensing system is subjected to sufficient surface tension forces to hold the dispensed fluid in place and in contact with the electrode.

A 50^{th} embodiment including the features of any of the 38^{th} through 49^{th} embodiment and wherein a fluid dispensing system uses surface tension to apply a layer of material to an electrode.

A 51^{st} embodiment including the features of any of the 38^{th} through 50^{th} embodiment and wherein a distance between the nozzle and the electrode is selected such that surface tension of the fluid is sufficient to hold the fluid on the electrode.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. A space-based sensor fabrication module comprising:
a fluid dispensing system, the fluid dispensing system comprising at least one reservoir, and at least one nozzle, wherein each nozzle corresponds to a reservoir;
at least one electrode; and
a press mechanism, the press mechanism capable of applying an external force on at least one of the at least one reservoir;
wherein the at least one reservoir dispenses a fluid onto the at least one electrode in response to the external force applied.

2. (canceled)

3. (canceled)

4. (canceled)

5. (canceled)

6. (canceled)

7. The space-based sensor fabrication module of claim 1, wherein the sensor fabrication system is capable of manufacturing a self-assembled monolayer.

8. (canceled)

9. (canceled)

10. (canceled)

11. The space-based sensor fabrication module of claim 1, wherein a nozzle positioning relative to the electrode is configured such that a fluid dispensed by the fluid dispensing system is subjected to sufficient surface tension forces to hold the dispensed fluid in place and in contact with the electrode.

12. (canceled)

13. (canceled)

14. A space-based sensor fabrication chamber comprising:
an outer wall;
a press mechanism;
at least one fabrication tray;
at least one fabrication module coupled to the at least one fabrication tray; and
at least one electrode;
wherein the fabrication module dispenses a fluid onto the at least one electrode in response to a force applied by the press mechanism.

15. (canceled)

16. The space-based sensor fabrication chamber of claim 14, wherein the at least one fabrication module comprises:
a fluid dispensing system, the fluid dispensing system comprising at least one reservoir, and at least one nozzle, wherein each nozzle corresponds to a reservoir;
at least one electrode; and
a press mechanism, the press mechanism capable of applying an external force on at least one of the at least one reservoir;
wherein the at least one reservoir dispenses a fluid onto the at least one electrode in response to the external force applied.

17. (canceled)

18. (canceled)

19. (canceled)

20. (canceled)

21. (canceled)

22. (canceled)

23. The space-based sensor fabrication chamber of claim 16, wherein the press mechanism comprises a control system, a motor, and a movable component.

24. (canceled)

25. (canceled)

26. (canceled)

27. The space-based sensor fabrication chamber of claim 16, wherein the sensor fabrication system is capable of manufacturing a self-assembled monolayer.

28. The space-based sensor fabrication chamber of claim 16, wherein the at least one reservoir comprises a first reservoir and a second reservoir, the at least one nozzle comprises a first nozzle and a second nozzle, and the at least one electrode comprises a first electrode and a second electrode.

29. (canceled)

30. The space-based sensor fabrication chamber of claim 16, wherein a distance between a reservoir tip and the at least one electrode is adjustable.

31. A space-based sensor fabrication system comprising:
a baseplate;
a fluid reservoir disposed on a top surface of the baseplate;
a pump in fluid communication with the fluid reservoir wherein the pump has at least one inlet and one outlet, where the inlet is configured to receive fluid from the fluid reservoir; and
a network of tubing connected to the at least one outlet and in fluid communication with the pump, wherein the network of tubing is disposed above the top surface of the baseplate and configured to dispense fluid through a plurality of fluid dispensing elements by surface tension application;
wherein each of the plurality of fluid dispensing elements corresponds to at least one blank and/or bare electrode, wherein each of the at least one blank and/or bare electrode is disposed on the top surface of the baseplate.

32. A fabrication chamber comprising:
a plurality of sensor fabrication systems, wherein each of the plurality of sensor fabrication systems comprises:
a baseplate;
a fluid reservoir disposed on a top surface of the baseplate;
a pump in fluid communication with the fluid reservoir wherein the pump has at least one inlet and one outlet, where the inlet is configured to receive fluid from the fluid reservoir; and
a network of tubing connected to the at least one outlet and in fluid communication with the pump, wherein the network of tubing is disposed above the top surface of the baseplate and configured to dispense fluid through a plurality of fluid dispensing elements by surface tension application;
wherein each of the plurality of fluid dispensing elements corresponds to at least one blank and/or bare electrode, wherein each of the at least one blank and/or bare electrode is disposed on the top surface of the baseplate; and
at least one control module, wherein the at least one control module is configured to control a functioning of each of the plurality of sensor fabrication systems.

33. A chemical deposition process to create a self-assembled monolayer in microgravity that comprises:
obtaining a bare surface for an application of a chemical substance;
applying a head group chemical to the bare surface; and
applying a functional tail group to a head group, wherein a functional group is configured to operate or interact with an external element thereby causing a reaction.

34. The chemical deposition process of claim 33, further comprising applying a spacer group between the head group and the functional tail group.

35. The chemical deposition process of claim 33, wherein the functional tail group further serves as a functionalized surface for an immobilization of a group consisting of polymers, chemicals, logical components, (oligo-) nucleotides, proteins, antibodies, and receptors.

36. A space-based sensor fabrication system comprising:
a baseplate; and
a fluid dispensing structure disposed on a top surface of the baseplate that has a flexible portion that serves as a fluid reservoir and dispensing nozzle. The structure has at least one inlet to load the fluid and one outlet to dispense;
wherein each of a plurality of fluid dispensing elements corresponds to at least one blank and/or bare electrode, wherein each of the at least one blank and/or bare electrode is disposed on the top surface of the baseplate.

37. A fabrication chamber comprising:
a plurality of sensor fabrication systems, wherein each of the plurality of sensor fabrication systems comprises:
a baseplate;
a fluid dispensing structure disposed on a top surface of the baseplate that has a flexible some that serves as a fluid reservoir and dispensing nozzle. The structure has at least one inlet to load the fluid and one outlet to dispense;
wherein each of a plurality of fluid dispensing elements corresponds to at least one blank and/or bare electrode, wherein each of the at least one blank and/or bare electrode is disposed on the top surface of the baseplate; and
at least one control module, wherein the at least one control module is configured to control a functioning of each of the plurality of sensor fabrication systems.

38. A method for space-based sensor fabrication, the method comprising:
providing a satellite in orbit; and
activating a press mechanism to apply an external force on at least one reservoir;
wherein the at least one reservoir dispenses a fluid through at least one nozzle onto an at least one electrode in response to the external force applied.

39. (canceled)

40. (canceled)

41. (canceled)

42. (canceled)

43. (canceled)

44. The method for space-based sensor fabrication of claim 38, wherein the method for space-based sensor fabrication is capable of manufacturing a self-assembled monolayer.

45. The method for space-based sensor fabrication of claim 38, wherein the at least one reservoir comprises a first reservoir and a second reservoir, the at least one nozzle comprises a first nozzle and a second nozzle, and the at least one electrode comprises a first electrode and a second electrode.

46. (canceled)

47. (canceled)

48. (canceled)

49. The method for space-based sensor fabrication of claim 38, wherein a fluid dispensing system uses surface tension to apply a layer of material to an electrode.

50. (canceled)
